(19) United States
(12) Patent Application Publication
(10) Pub. No.: US 2002/0198929 A1
(43) Pub. Date: Dec. 26, 2002

(54) Method and apparatus to encourage client into a distributed peer to peer sharing technology

(75) Inventors: Jeffrey Allen Jones, Round Rock, TX (US); Douglas Scott Rothert, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 09/888,472

(22) Filed: Jun. 25, 2001

(51) Int. Cl. G06F 15/16

(52) U.S. Cl. 709/201; 707/10

(57) ABSTRACT

A method, program and system to provide incentives for client machines to contribute resources to a peer-to-peer computer network are provided. When a server receives requests for information from a plurality of client machines, it determines if the client machines are contributing resources to peer-to-peer sharing. When answering requests, clients which contribute resources to peer-to-peer sharing are given priority over client which do not contribute. In another embodiment of the present invention, a further incentive is provided to clients which contribute to peer-to-peer sharing, by giving higher priority to client requests in proportion to the level of resources contributed.

### CROSS REFERENCE TO RELATED APPLICATIONS

The present application is related to co-pending U.S. patent application Ser. No. ______ (IBM Docket No. AUS920010398US1) entitled “Method and Apparatus for Wide-Spread Distribution of Electronic Content in a Non-Linear Peer to Peer Fashion” filed even date herewith. The content of the above mentioned commonly assigned, co-pending U.S. patent applications are hereby incorporated herein by reference for all purposes.

### BACKGROUND OF THE INVENTION

1. Technical Field

The present invention relates generally to computer network environments, and more specifically to the mass distribution of data.

2. Description of Related Art

Current technology for mass distribution of data over the Internet consists of one or more “master” servers where the content is available, and many more “mirror” sites where the same data is stored. These mirror sites do not actually use the data themselves. Typically, the master server is overwhelmed very easily, and end users are forced to manually attempt a list of mirror sites. Each of those mirror sites may or may not actually have the updated content because they are typically driven by time-based automation (typically a cron job scheduled at midnight). This distribution scheme is incredibly problematic and wasteful in dealing with the initial wave of interest in specific data.

Many of these problems may be reduced by using peer-to-peer technology to offload demands from master servers to other nearby clients which are downloading the same content for their own use. The master server divides a large file into several small pieces and then downloads those file pieces to the first client machines which request the file. For example, a 50 megabyte (MB) file may be broken into 50 1-MB pieces which are then downloaded to 50 different clients. These clients will then function as peer-to-peer servers. Subsequent requests from new client machines are then redirected by the master server to the clients which already have the required file pieces.

Because the client machine are owned by the end users, acquiring peer-to-peer connections may be a significant problem if people do not want to share their bandwidth and computer resources.

Therefore, it would be desirable to have a method for providing incentive for end users to allow their client machine to act as peer-to-peer servers.

### SUMMARY OF THE INVENTION

The present invention provides a method, program and system to provide incentives for client machines to contribute resources to a peer-to-peer computer network. When a server receives requests for information from a plurality of client machines, it determines if the client machines are contributing resources to peer-to-peer sharing. When answering requests, clients which contribute resources to peer-to-peer sharing are given priority over clients which do not contribute. In another embodiment of the present invention, a further incentive is provided to clients which contribute to peer-to-peer sharing, by giving higher priority to client requests in proportion to the level of resources contributed.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 depicts a block diagram of a data processing system that may be implemented as a server in accordance with a preferred embodiment of the present invention;

FIG. 3 depicts a block diagram illustrating a data processing system in which the present invention may be implemented; and

FIG. 4 depicts a flowchart illustrating a method for encouraging clients to contribute resources to peer-to-peer sharing in accordance with the present invention.

### DETAILED DESCRIPTION OF THE PREFERRED EMBODIMENT

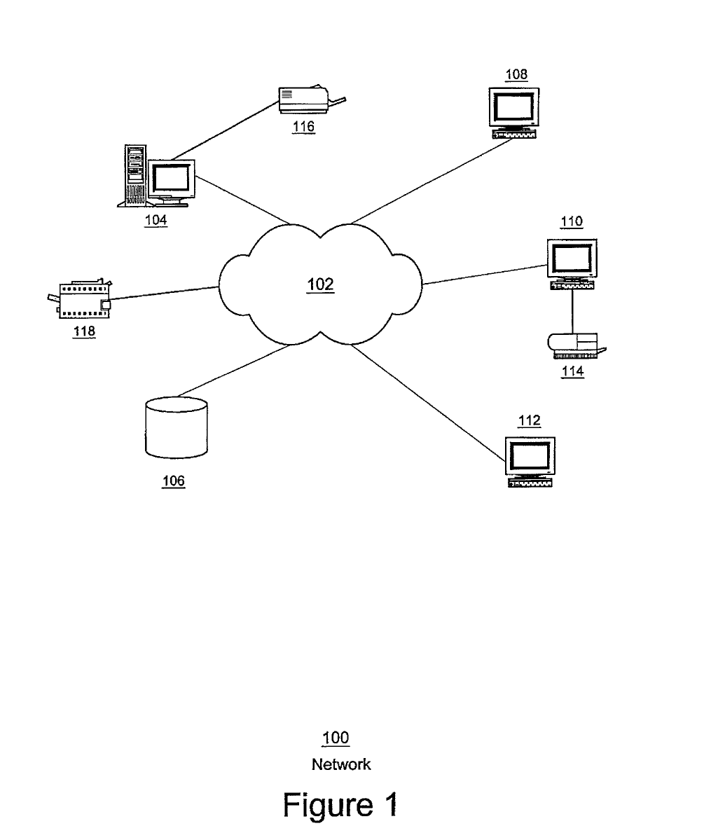

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

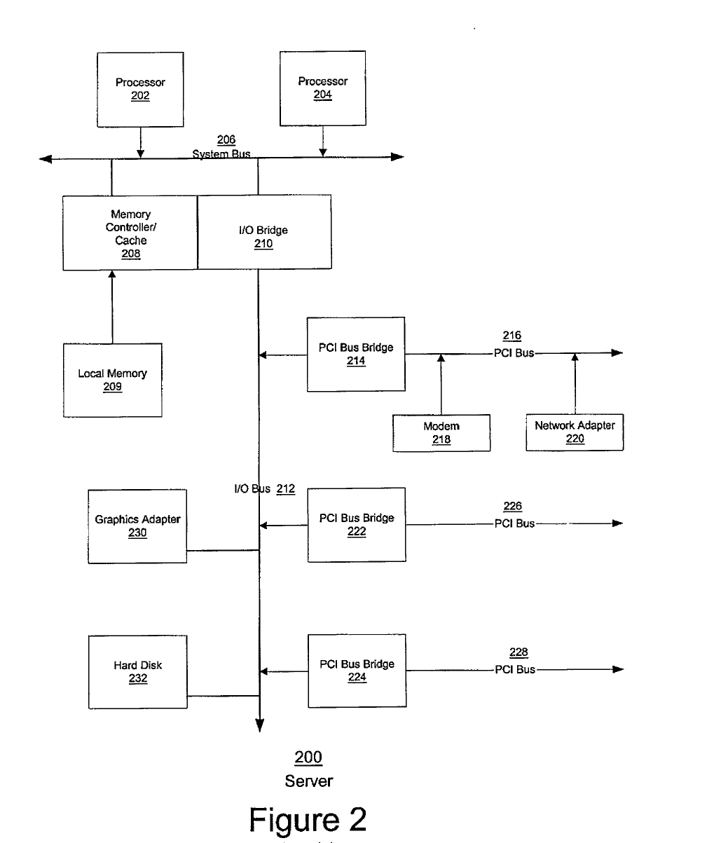

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

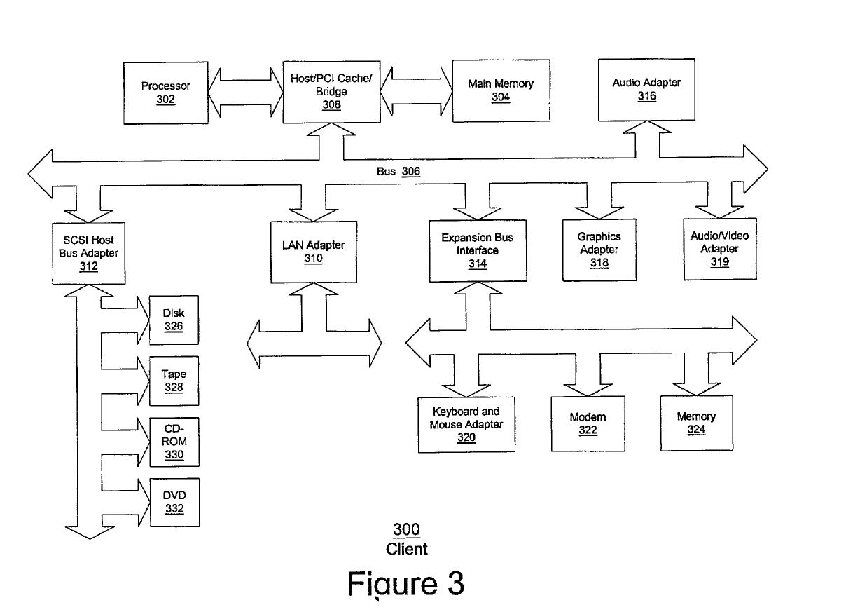

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, CD-ROM drive 330, and DVD drive 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

In peer-to-peer data distribution, acquiring peer-to-peer connections may be a significant problem if end users do not want to share their bandwidth and computer resources. The present invention provides incentives for the owners of client machines to contribute their resources to peer-to-peer sharing technology.

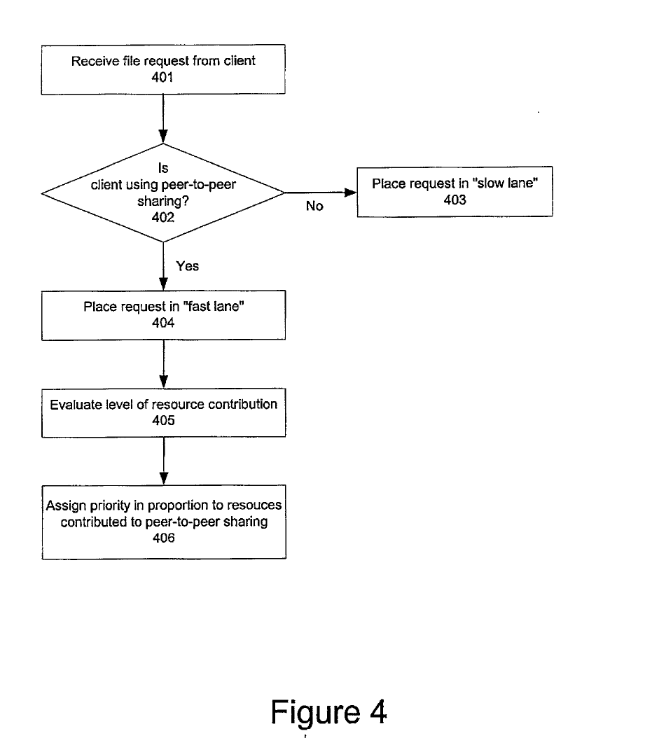

Referring to FIG. 4, a flowchart illustrating a method for encouraging clients to contribute resources to peer-to-peer sharing is depicted in accordance with the present invention. On the master server, requests for files will be answered first for peer-to-peer servers and secondly for clients in the normal fashion used today. When the master server receives a file request from a client (step 401), the master determines if that client has adopted peer-to-peer sharing technology (step 402). If the client is not contributing resources for peer-to-peer sharing, the file request will still be granted, but the request is placed into the “slow lane” of the pending file transfers (step 403). If the client is contributing resources for peer-to-peer sharing, the master server places the request in the “fast lane” (step 404). Client requests given fast lane status are always given higher priority than requests with slow lane status.

In contributing to peer-to-peer sharing, clients would be allowed to delegate a “sandbox” for the protocol to use. This includes specific disk space limits, bandwidth limits, CPU limits, memory limits, and limits on number of users connecting.

The caveat of the present approach is that some users may select minimal resources necessary in order to get into the fast lane of the peer-to-peer servers. To address the problem, the master server maintains a priority queue for requests that are in the fast lane. This priority queue evaluates the level of resources that the peer-to-peer client has contributed to sharing technology (step 405). The priority queue considers factors such as the client's resources and the client's past history of serving other clients. Priority within the queue is then assigned in proportion to the total resources contributed to the peer-to-peer sharing technology (step 406). This priority queue adds another layer of priority to client requests, on top of the fast lane/slow lane distinction described above. Therefore, end users have an incentive to offer more resources (bandwidth, disk space, CPU, memory, etc.) towards sharing so that they receive files faster.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method to provide incentives for client machines to contribute resources to a peer-to-peer computer network, the method comprising:
receiving requests for information from a plurality of client machines;
determining if the client machines are contributing resources to peer-to-peer sharing; and
sending the requested information to the client machines, wherein priority is given to requests from clients which are contributing resources to peer-to-peer sharing.

2. The method according to claim 1, wherein the step of giving priority to client machines which contribute resources to peer-to-peer sharing further comprises giving higher priority in proportion to the level of resources contributed.

3. The method according to claim 1, wherein the resources client machines may contribute to peer-to-peer sharing comprise:
disk space;
bandwidth;
CPU resources;
memory; and
specified number of connecting users.

4. A method for accessing information in a peer-to-peer computer network, the method comprising:
contributing computer resources to peer-to-peer sharing technology;
requesting information from a network server, wherein the request is given priority in proportion to the level of resources contributed to peer-to-peer sharing; and
receiving the requested information.

5. The method according to claim 4, wherein the resources contributed to peer-to-peer sharing comprise:
disk space;
bandwidth;
CPU resources;
memory; and
specified number of connecting users.

6. A computer program product in a computer readable medium for use in a data processing system, to provide incentives for client machines to contribute resources to a peer-to-peer computer network, the computer program product comprising:
instructions for receiving requests for information from a plurality of client machines;
instructions for determining if the client machines are contributing resources to peer-to-peer sharing; and
instructions for sending the requested information to the client machines, wherein priority is given to requests from clients which are contributing resources to peer-to-peer sharing.

7. The computer program product according to claim 6, wherein the instructions for giving priority to client machines which contribute resources to peer-to-peer sharing further comprise instructions for giving higher priority in proportion to the level of resources contributed.

8. The computer program product according to claim 6, wherein the resources client machines may contribute to peer-to-peer sharing comprise:
disk space;
bandwidth;
CPU resources;
memory; and
specified number of connecting users.

9. A computer program product in a computer readable medium for use in a data processing system, for accessing information in a peer-to-peer computer network, the method comprising:
instructions for contributing computer resources to peer-to-peer sharing technology;
instructions for requesting information from a network server, wherein the request is given priority in proportion to the level of resources contributed to peer-to-peer sharing; and
instructions for receiving the requested information.

10. The computer program product according to claim 9, wherein the resources contributed to peer-to-peer sharing comprise:
disk space;
bandwidth;
CPU resources;
memory; and
specified number of connecting users.

11. A system to provide incentives for client machines to contribute resources to a peer-to-peer computer network, the system comprising:
a receiving component which receives requests for information from a plurality of client machines;
a processing component which determines if the client machines are contributing resources to peer-to-peer sharing;
a register which maintains a queue, wherein priority is given to requests from clients which are contributing resources to peer-to-peer sharing; and
a communications component which sends the requested information to the client machines.

12. The system according to claim 11, wherein the register which maintains the queue further comprises a second queue for requests from clients which contribute resources, wherein higher priority is given in proportion to the level of resources contributed.

13. The system according to claim 11, wherein the resources client machines may contribute to peer-to-peer sharing comprise:
disk space;
bandwidth;
CPU resources;
memory; and
specified number of connecting users.

14. A system for accessing information in a peer-to-peer computer network, the method comprising:
a peer-to-peer sharing component which contributes computer resources to peer-to-peer sharing technology;
a communications component which requests information from a network server, wherein the request is given priority in proportion to the level of resources contributed to peer-to-peer sharing; and
a receiving component which receives the requested information.

15. The system according to claim 14, wherein the resources contributed to peer-to-peer sharing comprise:
disk space;
bandwidth;
CPU resources;
memory; and
specified number of connecting users.
